(19) United States
(12) Patent Application Publication
(10) Pub. No.: US 2011/0063204 A1
(43) Pub. Date: Mar. 17, 2011

(54) Electronic paper display device

(75) Inventors: Jeong Bok Kwak, Suwon-si (KR); Hwan Soo Lee, Seoul (KR); Young Woo Lee, Suwon-si (KR); Sang Moon Lee, Seoul (KR)

(73) Assignee: SAMSUNG ELECTRO-MECHANICS CO., LTD., Suwon (KR)

(21) Appl. No.: 12/654,941

(22) Filed: Jan. 8, 2010

(30) Foreign Application Priority Data
Sep. 14, 2009 (KR) 10-2009-0086465

(51) Int. Cl. G09G 3/34

(52) U.S. Cl. 345/107

(57) ABSTRACT

The present invention relates to an electronic paper display device and the electronic paper display device includes: a lower substrate in which an extruded pattern partitioning a cell is provided on one surface thereof; one or more display units that are disposed to have different sizes in the cell; and an upper substrate that is laminated on the top of the extruded pattern while covering the display unit, wherein the brightness is adjusted by differences in the size, specific gravity, and the quantity of charges of the display unit.

### CROSS-REFERENCE TO RELATED APPLICATIONS

This application claims the benefit of Korean Patent Application No. 10-2009-0086465 filed with the Korea Intellectual Property Office on Sep. 14, 2009, the disclosure of which is incorporated herein by reference.

### BACKGROUND OF THE INVENTION

1. Field of the Invention

The present invention relates to an electronic paper display device, and, and more particularly, to an electronic paper display device capable of adjusting the brightness of a display device by controlling the size, specific gravity, and charge quantity of an electronic ball disposed in each cell.

2. Description of the Related Art

In recent years, technology development of an electronic paper, as a next-generation display device, having an advantage of being flexibly bent has been accelerated.

Since the electronic paper display device is lower in manufacturing cost than other display devices and does not need background lighting or consistent recharging in addition to being flexibly bent to be actuated at low energy, the electronic paper display device is excellent in energy efficiency.

Further, since the electronic paper display device has clear image quality and a wide viewing angle, and also has a memory function to prevent displayed characters or images from disappearing even though power is instantaneously interrupted, it is expected that the electronic paper display device can be widely used in a wide-range field including bendable screens and electronic walls, etc. in addition to print media such as books, newspapers, magazines, or the like.

Meanwhile, a technical scheme capable of implementing the electronic paper display device is being developed by being largely classified into a scheme using liquid crystals, an organic EL scheme, a reflection film reflective display scheme, an electrophoresis scheme, a twist ball scheme, an electrochromic scheme, a mechanical reflective display scheme, etc.

Among them, the electronic paper display device using the twist ball (alternatively, referred to as ‘electronic ball’) includes two electrodes and an elastomer matrix that is interposed between two electrodes and attached with the twist ball having optical and electrical anisotropy.

A peripheral surface of the twist ball is coated with dielectric liquid and the twist ball may be constituted by a block hemisphere and a white hemisphere that are charged with different charges.

When voltage is applied to two electrodes, the hemispheres rotate to face electrode surfaces having polarities opposite to each other in the dielectric liquid depending on the direction of the applied voltage, such that the electronic paper display device displays black and white colors.

However, the known electronic paper display device using the twist ball has a problem in that it is difficult to control the brightness by using the same twist ball.

### SUMMARY OF THE INVENTION

It is, therefore, an object of the present invention to provide an electronic paper display device capable of adjusting the brightness of a display device for each use environment by variously controlling a rotation angle of an electronic ball disposed in each cell.

In accordance with a first aspect of the present invention, an electronic paper display device may include: a lower substrate in which an extruded pattern partitioning a cell is provided on one surface thereof; one or more display units that are disposed to have different sizes in the cell; and an upper substrate that is laminated on the top of the extruded pattern while covering the display unit.

In accordance with a second aspect of the present invention, an electronic paper display device may include: a lower substrate in which an extruded pattern partitioning a cell is provided on one surface thereof; one or more display units that are disposed to have a difference in ratio between (+) charge particles and (−) charge particles in the cell; and an upper substrate that is laminated on the top of the extruded pattern while covering the display unit.

In accordance with a third aspect of the present invention, an electronic paper display device may include: a lower substrate in which an extruded pattern partitioning a cell is provided on one surface thereof; one or more display units that are disposed to have a difference in specific gravity of charged particles in the cell; and an upper substrate that is laminated on the top of the extruded pattern while covering the display unit.

In accordance with a fourth aspect of the present invention, an electronic paper display device may include: a lower substrate in which an extruded pattern partitioning a cell is provided on one surface thereof; one or more display units that are disposed in the cell; and an upper substrate that is laminated on the top of the extruded pattern while covering the display unit, wherein the display unit is an electronic ball including (+) charged particles and (−) charged particles diffused in flowable liquid and has two or more characteristics of a difference in size of the display units, a difference in specific gravity of the charge particles, and a difference in ratio between the (+) charged particles and the (−) charge particles.

Further, the display unit of the electronic paper display device in accordance with the present invention may be formed by an electronic ball including (+) charged particles and (−) charged particles that are diffused in flowable liquid.

Further, the size of the cell in the electronic paper display device in accordance with the present invention may be partitioned to correspond to the size of the display unit.

Further, any one of the (+) charge particles and the (−) charged particles in the electronic paper display device in accordance with the present invention may be formed by a black particle made of carbon black and the other is formed by a black particle made of titanium oxide.

Further, the display unit in the electronic paper display device in accordance with the present invention may be a rotating body having optical and electrical anisotropy.

Further, the extruded pattern in the electronic paper display device in accordance with the present invention may be made of at least one selected from a group consisting of polycarbonate (PC), polyethylene terephthalate (PET), polyethersulfone (PES), polyimide, an epoxy-based material, an urethane-based material, and a polyester-based material.

Further, the size of the cell in the electronic paper display device in accordance with the present invention may be uniformly partitioned.

Further, the height of the extruded pattern in the electronic paper display device in accordance with the present invention may be equal to or smaller than that of the display unit.

Further, the difference in specific gravity of the charge particles in the electronic paper display device in accordance with the present invention may be determined by controlling the quantity of the (+) charge particles or the (−) charge particles that are included in the display unit.

Further, the difference in specific gravity of the charge particles in the electronic paper display device in accordance with the present invention may be determined by controlling components or mass of flowable liquid.

In accordance with an embodiment of the present invention, it is possible to adjust the brightness by controlling the number of display units and a rotation angle of the display unit through the size, mass, and charge quantity of the display unit.

Further, since the display unit can be injected only into cells which are the pixel space by using an array mask, and intervals and shapes of the display units injected into the cells can be uniformly formed for each cell, it is possible to improve an image quality by removing stains or spots on a screen.

### BRIEF DESCRIPTION OF THE DRAWINGS

These and/or other aspects and advantages of the present general inventive concept will become apparent and more readily appreciated from the following description of the embodiments, taken in conjunction with the accompanying drawings of which:

FIG. 1 is a cross-sectional view of an electronic paper display device in accordance with an embodiment of the present invention;

FIG. 2 is a diagram showing display units of an electronic paper display devices, which have various sizes in accordance with an embodiment of the present invention;

As shown in FIGS. 3A to 3D, the brightness can be adjusted at four levels depending on the number of display units 40 disposed in the same pixel (configured by four cells); and

FIG. 4 is a diagram showing a display unit of an electronic paper display device in accordance with an embodiment of the present invention.

### DETAILED DESCRIPTION OF THE PREFERABLE EMBODIMENTS

Although the present invention can be modified variously and have several embodiments, the exemplary embodiments are illustrated in the accompanying drawings and will be described in detail in the detailed description. However, the present invention is not limited to the specific embodiments and should be construed as including all the changes, equivalents, and substitutions included in the spirit and scope of the present invention. Further, in describing the present invention, well-known functions or constructions will not be described in detail since they may unnecessarily obscure the understanding of the present invention.

The terms used in the specification is used to describe only specific embodiments and is not intended to limit the present invention. The singular forms are intended to include the plural forms unless the context clearly indicates otherwise.

Hereinafter, an electronic paper display device in accordance with an embodiment of the present invention will be described in detail with reference to the accompanying drawings. Like elements refer to like reference numerals and a duplicated description thereof will be omitted.

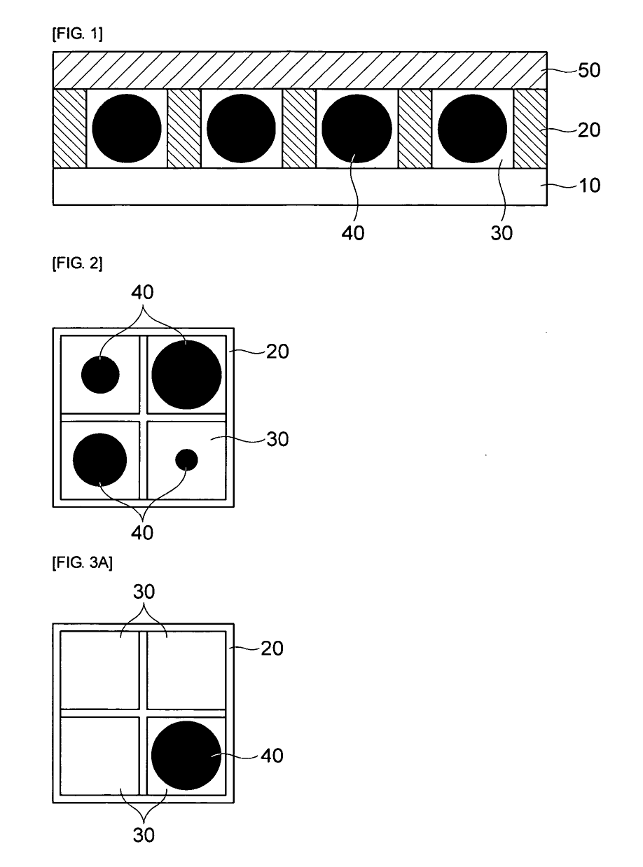

FIG. 1 is a cross-sectional view of an electronic paper display device in accordance with an embodiment of the present invention.

As shown in FIG. 1, the electronic paper display device in accordance with the embodiment of the present invention includes a lower substrate 10 having an extruded pattern 20, at least one display unit 40, and an upper substrate 50.

First, an embodiment of a method of forming the extruded pattern 20 partitioning cells 30 on one surface of the lower substrate 10 will be described.

A resin layer is laminated on the lower substrate 10 and thereafter, the resin layer is pressed by using a stamp having the extruded pattern. Thereafter, the extruded pattern 20 can be formed on the lower substrate 10 by using separating the resin layer and the stamp from each other.

The resin layer can use a thermosetting epoxy material and can dualize an imprint process in order to more efficiently the extruded pattern 20.

That is, after the stamp and the resin layer are thermopressed for 30 minutes within a temperature range (i.e., approximately 100° C.) where the resin layer has the lowest viscosity, the resin layer is cured by increasing temperature up to a temperature range (i.e., approximately 180° C.) where the resin layer can be cured under a pressed state. Therefore, a method of separating the stamp and the resin layer can be used.

Further, although the imprint process using the stamp has been described as the method of forming the extruded pattern 20 partitioning the cell 30, the method is not limited to the imprint process and the extruded pattern 20 may be formed by using various methods such as drying or wet etching, etc.

The upper substrate 50 laminated on the top of the extruded pattern 20 covers the display unit 40 disposed in the cell 30.

The lower substrate 10 and the upper substrate 50 are constituted by electrodes formed by coating a transparent electrode of indium-tin-oxide (ITO) or a conductive polymer on a transparent substrate made of glass or plastic.

Accordingly, it is possible to induce charged particles by applying voltage to the electrode formed on the transparent substrate.

Further, as a material of the extruded pattern 20, at least one may be selected from a group consisting of polycarbonate (PC), polyethylene terephthalate (PET), polyethersulfone (PES), polyimide, an epoxy-based material, an urethane-based material, and a polyester-based material.

The cells 30 partitioned by the extruded pattern 20 provided on the lower substrate 10 may be partitioned in the uniform size or partitioned to correspond to the size of the display unit 40 disposed in the cell 30.

The extruded pattern 20 formed at the outermost area of the lower substrate 10 may be higher than the other extruded patterns 20 and the height of the extruded pattern 20 may be lower than that of the display unit 40.

Next, the display unit 40 is disposed in the cell 30 partitioned by the extruded pattern 20. The display unit 40, a means expressing a black color, a white color, or other colors, may be formed by an electron ball including (+) charged particles and (−) charged particles that are diffused in flowable liquid in the embodiment of the present invention.

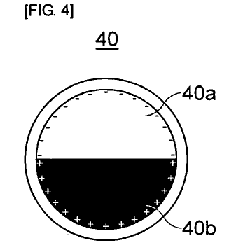

In the display unit 40, any one of the (+) charged particles and (−) charged particles may be a back particle 40b made of carbon black and the other may be formed by a white particle 40a made of titanium oxide (see FIG. 4).

The display unit 40 is a rotating body having optical and electrical anisotropy. When an electric field is applied from the upper substrate 50 and the lower substrate 10, the display unit 40 rotates depending on polarities of the charged particles included in the display unit 40 and is arranged to correspond to the direction of the electric field.

The display unit 40 of the electronic paper display device in accordance with the embodiment of the present invention can adjust the brightness by controlling characteristics of the display unit 40 such as the size, specific gravity, charge amount, etc.

### First Embodiment

The brightness of the electronic paper display device in accordance with the present invention may be adjusted depending on the size of the display unit.

The display unit 40 in accordance with the first embodiment has the same characteristics except for the size of the display unit 40.

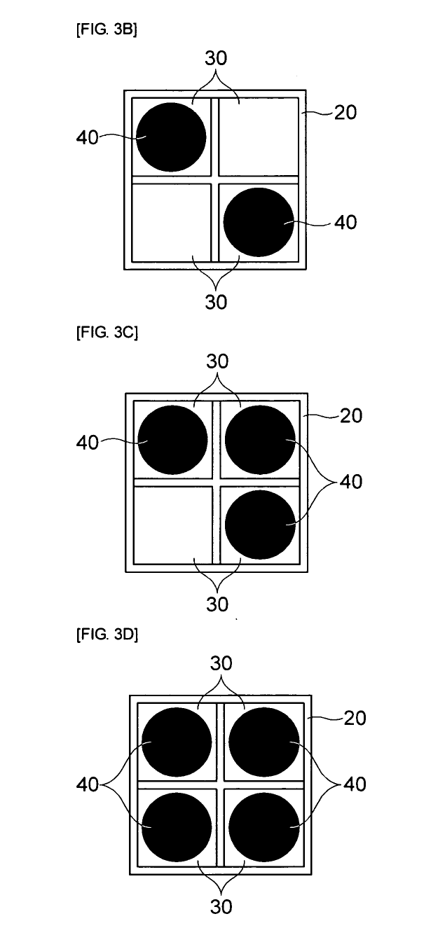

FIG. 2 is a diagram showing display units of an electronic paper display devices, which have various sizes in accordance with an embodiment of the present invention.

As shown in FIG. 2, the display units 40 may have various sizes and the quantity of charged particles included therein may depend on the size of the display unit 40.

The display units 40 having different sizes may be disposed in the cells 30 having the same size and may be disposed in cells having different sizes depending on the size of the display unit 40.

A mask can be manufactured depending on the size of the display unit 40 in order to dispose the display units 40 having different sizes in the partitioned cells 30.

Since the display unit 40 can be formed by an electronic ball including (+) charged particles and (−) charged particles that are diffused in flowable liquid, the entire mass and the quantity of charged particles that are included in the display unit 40 are also increased with an increase in size of the display unit 40.

When an electrical field having the same intensity is applied from the upper substrate 50 and the lower substrate 10, the number, rotation speed, and rotation angle of the display units 40 that rotate depend on a difference in size.

Accordingly, since the brightness can be adjusted at various steps by forming the display units 40 in various sizes depending on a use environment and a characteristic of an applied product, it is possible to secure the reliability of adjusting the brightness.

### Second Embodiment

The brightness of the electronic paper display device in accordance with the present invention may be adjusted depending on the specific of each display unit.

A difference in specific gravity of the charged particles included in the display units 40 can vary by adjusting the quantity of charged particles and the amount of flowable liquid that are included in the display units 40.

The display unit 40 in accordance with the second embodiment has the same characteristics except for the specific gravity of charged particles included in the display units 40.

First, a difference in specific gravity of the charged particles included in the display units 40 can be determined by adjusting the quantity of (+) charged particles and (−) charged particles that are included in the display units 40.

For example, when the quantity of (+) charged particles or (−) charged particles is increased with respect to constant flowable liquid configuring the display units 40 having the same size, the rotation number, rotation angle, and rotation angle of the display units 40 can be increased even when a comparatively low electrical field is applied.

Further, the specific gravities of the charged particles and the flowable liquid can be adjusted by controlling components or mass of the flowable liquid.

For example, when the amount of flowable liquid is increased with respect to the constant quantity of charged particles configuring the display units 40 having the same size, the display unit 40 can be rotated only by applying a comparatively high electric field.

FIGS. 3A to 3D are diagrams showing display units of an electronic paper display devices, which have various specific gravities in accordance with an embodiment of the present invention.

As shown in FIGS. 3A to 3D, the brightness can be adjusted at four levels depending on the number of display units 40 disposed in the same pixel (configured by four cells).

That is, when compared with FIGS. 3B and 3D, since the specific gravity of the display unit 40 in FIG. 3D is increased double more than that in FIG. 3B, FIG. 3D is represented by higher brightness than FIG. 3B even by applying the same electric field.

Accordingly, when the display units 40 having the same size and different specific gravities are used, it is possible to easily manufacture a mask and secure the reliability of adjusting the brightness of the electronic paper display device.

### Third Embodiment

The brightness of the electronic paper display device in accordance with the present invention may be adjusted depending on the quantity of charges of each display unit.

The display units 40 in accordance with the third embodiment have the same characteristics except for the quantity of charges included in the display units 40.

It is possible to adjust the brightness by maintaining the size and specific gravity of the display unit 40 constantly and changing only the quantity of charges. Herein, the quantity of charges of the display unit 40 is determined by a ratio or the quantity of (+) charged particles or (−) charged particles.

That is, when a difference in ratio between the (+) charged particles and (−) charged particles varies, the rotation angle of the display unit 40 can vary.

Further, when the entire quantity of the (+) charged particles and the (−) charged particles vary, the rotation number, rotation speed, and rotation angle of the display unit 40 can vary.

In the display unit 40, since any one of the (+) charged particles and the (−) charged particles is formed by a black particle made of carbon black and the other is formed by a white particle made of titanium oxide, the brightness can be adjusted depending on the ratio of charge particles.

Further, since the charge particles can be formed by particles having other colors other than the black particle and the white particle, the charged particles will be applied to adjustment of the brightness of the display device which can implement a color.

### Fourth Embodiment

The brightness of the electronic paper display device in accordance with the present invention may be adjusted depending on at least two characteristics of the size, specific gravity, and the quantity of charges of each display unit.

The brightness of the display unit 40 in accordance with the fourth embodiment can be adjusted by at least two characteristics of a difference in size of the display units, a difference in specific gravity of the charged particles, and a difference in ratio between the (+) charged particles and the (−) charged particles.

For example, the display unit 40 can be disposed, which maintains the size of the display unit 40 disposed in the cell 30 constantly and has only two different characteristics such as the specific gravity and the quantity of charges.

In this case, since the brightness is adjusted by two factors such as the specific gravity and the quantity of charges, the brightness having various levels can be adjusted rather than a case in which the brightness is adjusted only by one characteristic.

In the same method as above, the brightness can be adjusted by maintaining the specific gravity of each display unit 40 constantly, varying the size and the quantity of charges, or maintaining the amount of charges constantly and varying the size and the specific gravity.

Further, the brightness can be adjusted by controlling the size, the specific gravity, and the quantity of charges of the display units 40 differently.

As described above, although the preferable embodiments of the present invention have been shown and described, it will be appreciated by those skilled in the art that substitutions, modifications and changes may be made in these embodiments without departing from the principles and spirit of the general inventive concept, the scope of which is defined in the appended claims and their equivalents.

1. An electronic paper display device, comprising:
a lower substrate in which an extruded pattern partitioning a cell is provided on one surface thereof;
one or more display units that are disposed to have different sizes in the cell; and
an upper substrate that is laminated on the top of the extruded pattern while covering the display unit.

2. An electronic paper display device, comprising:
a lower substrate in which an extruded pattern partitioning a cell is provided on one surface thereof;
one or more display units that are disposed to have a difference in ratio between (+) charge particles and (−) charge particles in the cell; and
an upper substrate that is laminated on the top of the extruded pattern while covering the display unit.

3. An electronic paper display device, comprising:
a lower substrate in which an extruded pattern partitioning a cell is provided on one surface thereof;
one or more display units that are disposed to have a difference in specific gravity of charged particles in the cell; and
an upper substrate that is laminated on the top of the extruded pattern while covering the display unit.

4. An electronic paper display device, comprising:
a lower substrate in which an extruded pattern partitioning a cell is provided on one surface thereof;
one or more display units that are disposed in the cell; and
an upper substrate that is laminated on the top of the extruded pattern while covering the display unit,
wherein the display unit includes (+) charged particles and (−) charged particles and has two or more characteristics of a difference in size of the display units, a difference in specific gravity of the charge particles, and a difference in ratio between the (+) charged particles and the (−) charge particles.

5. The electronic paper display device in accordance with claim 1, wherein the display unit is formed by an electronic ball including (+) charged particles and (−) charged particles that are diffused in flowable liquid.

6. The electronic paper display device in accordance with claim 1, wherein the size of the cell is partitioned to correspond to the size of the display unit.

7. The electronic paper display device in accordance with claim 2, wherein any one of the (+) charge particles and the (−) charged particles is formed by a black particle made of carbon black and the other is formed by a black particle made of titanium oxide.

8. The electronic paper display device in accordance with claim 5, wherein any one of the (+) charge particles and the (−) charged particles is formed by a black particle made of carbon black and the other is formed by a black particle made of titanium oxide.

9. The electronic paper display device in accordance with claim 1, wherein the display unit is a rotating body having optical and electrical anisotropy.

10. The electronic paper display device in accordance with claim 1, wherein the size of the cell is uniformly partitioned.

11. The electronic paper display device in accordance with claim 1, wherein the height of the extruded pattern is equal to or smaller than that of the display unit.

12. The electronic paper display device in accordance with claim 1, wherein the extruded pattern is made of at least one selected from a group consisting of polycarbonate (PC), polyethylene terephthalate (PET), polyethersulfone (PES), polyimide, an epoxy-based material, an urethane-based material, and a polyester-based material.

13. The electronic paper display device in accordance with claim 3, wherein the difference in specific gravity of the charge particles is determined by controlling the quantity of the (+) charge particles or the (−) charge particles that are included in the display unit.

14. The electronic paper display device in accordance with claim 3, wherein the difference in specific gravity of the charge particles is determined by controlling components or mass of flowable liquid.
